(19) United States
(12) Patent Application Publication
(10) Pub. No.: US 2026/0280119 A1
(43) Pub. Date: Sep. 17, 2026

(54) FEED NETWORK ASSEMBLY, PHASE SHIFTER, AND ANTENNA APPARATUS

(71) Applicant: HUAWEI TECHNOLOGIES CO., LTD., Shenzhen (CN)

(72) Inventors: Chaochao Li, Xi'an (CN); Li Jin, Xi'an (CN); Qiqiang Gao, Dongguan (CN); Yuyang Yuan, Xi'an (CN)

(21) Appl. No.: 19/673,545

(22) Filed: May 11, 2026

Related U.S. Application Data
(63) Continuation of application No. PCT/CN2024/126647, filed on Oct. 23, 2024.

(30) Foreign Application Priority Data
Nov. 13, 2023 (CN) 202311508705.X

(51) Int. Cl. H01Q 3/30; H01Q 1/24

(52) U.S. Cl. CPC H01Q 3/30; H01Q 1/246

(57) ABSTRACT

The present invention discloses a feed network assembly, a phase shifter, and an antenna apparatus, to resolve a problem where transmission efficiency is affected because resonance is formed in an area in which metal plates face each other. This application provides a feed network assembly. The feed network includes a cavity and a transmission structure. The cavity includes an accommodating cavity configured to accommodate the transmission structure. The cavity further includes a first side wall, the first side wall includes a first sub-side wall and a second sub-side wall that are oppositely disposed and capacitively coupled, and at least one of the first sub-side wall and the second sub-side wall that are oppositely disposed and capacitively coupled includes at least one slot.

### CROSS-REFERENCE TO RELATED APPLICATIONS

This application is a continuation of International Application No. PCT/CN2024/126647, filed on Oct. 23, 2024, which claims priority to Chinese Patent Application No. 202311508705.X, filed on Nov. 13, 2023. The disclosures of the aforementioned applications are hereby incorporated by reference in their entireties.

### TECHNICAL FIELD

The present invention relates to the field of antenna technologies, and in particular, to a feed network assembly, a phase shifter, and an antenna apparatus.

### BACKGROUND

As a core component of a base station antenna, a feed network is used to change a phase of a radiating element to implement downtilt of an antenna beam. As shown in FIG. 1A, a feed network in a conventional technology includes a transmission structure and a closed metal cavity, and the transmission structure includes a strip and a phase-shift medium. The strip is located between an upper metal ground plane and a lower metal ground plane, and the phase-shift medium is separately located between two sides of the strip and between the strip and the metal ground plane. The closed metal cavity is usually made of a profile or sheet metal, and every two adjacent walls in four walls are directly connected to form a four-side closed cavity structure, to prevent an electric field inside the feed network from radiating to the outside. However, in this method, cavity processing costs are high. To reduce costs, in another conventional technology, an accommodating cavity is constructed through capacitive coupling. However, in this method, because capacitive coupling is implemented through metal plates being oppositely disposed, resonance is formed in an area in which the metal plates face each other, affecting transmission efficiency.

### SUMMARY

An objective of the present invention is to provide a feed network assembly, a phase shifter, and an antenna apparatus, to resolve a technical problem in a conventional technology.

According to a first aspect, an embodiment of this application provides a feed network assembly. The feed network includes a cavity and a transmission structure. The cavity includes an accommodating cavity, and the accommodating cavity is configured to accommodate the transmission structure. The cavity further includes a first side wall, the first side wall includes a first sub-side wall and a second sub-side wall that are oppositely disposed and capacitively coupled, and at least one of the first sub-side wall and the second sub-side wall that are oppositely disposed and capacitively coupled includes at least one slot.

In this application, slots are formed in the first sub-side wall and the second sub-side wall that are oppositely disposed and capacitively coupled, so that an area of relative disposition is reduced, thereby reducing resonance and improving transmission efficiency.

In some possible embodiments, the first side wall is a side wall of the accommodating cavity, and the first sub-side wall is integrally connected to a side wall of the accommodating cavity.

In this application, a plurality of manners of disposing the first sub-side wall are provided, making this application more universal.

In some possible embodiments, in the first sub-side wall and the second sub-side wall that are oppositely disposed and capacitively coupled, the first sub-side wall includes at least two first slots, and the second sub-side wall includes at least two second slots; and the first slot and the second slot are staggered.

In this application, when there are a large quantity of slots, the slots may be staggered, to ensure stability of the feed network assembly.

In some possible embodiments, in the first sub-side wall and the second sub-side wall that are oppositely disposed and capacitively coupled, the first sub-side wall includes at least two first slots, and the second sub-side wall includes at least two second slots; and the first slot and the second slot are oppositely formed.

In this application, the slots may alternatively be oppositely formed, making this application more universal.

In some possible embodiments, the feed network further includes at least one intermediate baffle plate, the intermediate baffle plate is disposed in the accommodating cavity, the intermediate baffle plate divides the accommodating cavity into at least two accommodating sub-cavities, and the transmission structure is disposed in each accommodating sub-cavity; and at least one end of the intermediate baffle plate is coupled to a side wall of the accommodating cavity.

In this application, the intermediate baffle plate is disposed to divide the accommodating cavity into a plurality of accommodating sub-cavities. In this way, transmission structures in different accommodating sub-cavities may be connected to radiating elements with different polarizations of an antenna apparatus, so that requirements of the radiating elements with different polarizations can be met through one feed network, thereby simplifying a structure of the feed network and reducing costs.

In some possible embodiments, a target end and the side wall of the accommodating cavity are oppositely disposed, and at least one of the target end and the side wall of the accommodating cavity that are oppositely disposed includes at least one slot; and the target end is an end that is of the intermediate baffle plate and that is coupled to the side wall of the accommodating cavity.

In this application, slots are formed in the target end and the side wall of the accommodating cavity that are oppositely disposed and capacitively coupled, so that an area of relative disposition is reduced, thereby reducing resonance and improving transmission efficiency.

In some possible embodiments, in the target end and the side wall of the accommodating cavity that are oppositely disposed, the target end includes at least two third slots, and the side wall of the accommodating cavity includes at least two fourth slots; and the third slot and the fourth slot are staggered.

In this application, when there are a large quantity of slots, the slots may be staggered, to ensure stability of the feed network assembly.

In some possible embodiments, in the target end and the side wall of the accommodating cavity that are oppositely disposed, the target end includes at least two third slots, and the side wall of the accommodating cavity includes at least two fourth slots; and the third slot and the fourth slot are oppositely formed.

In this application, the slots may alternatively be oppositely formed, making this application more universal.

In some possible embodiments, at least one of the first sub-side wall and the second sub-side wall that are oppositely disposed and capacitively coupled includes at least two slots arranged in a first direction, and a distance between adjacent slots in the first direction in the at least two slots arranged in the first direction is a preset distance.

In some possible embodiments, the preset distance is an integer multiple of a quarter of an operating wavelength, and the operating wavelength is an operating wavelength of an antenna apparatus corresponding to the feed network assembly.

In some possible embodiments, a depth of the slot in a second direction is greater than a width of a coupling area, and the coupling area is a coupling connection area in which the slot is located.

In this application, the depth of the slot is set to be greater than the width of the coupling area, so that an area in which the first sub-side wall and the second sub-side wall are oppositely disposed is reduced, thereby reducing resonance.

In some possible embodiments, a length of the slot in the first direction is less than a half of the operating wavelength, and the operating wavelength is the operating wavelength of the antenna apparatus corresponding to the feed network assembly.

In this application, a distance between adjacent slots is set to be less than the preset distance, so that resonance generated because metal on two sides of the slots forms a coupling connection due to a gap in the middle is avoided, thereby further ensuring transmission efficiency.

According to a second aspect, another embodiment of this application further provides a phase shifter. The phase shifter includes the feed network assembly according to the first aspect.

According to the phase shifter provided in this embodiment of this application, the foregoing feed network is disposed, so that processing and assembly are convenient, thereby reducing costs.

According to a third aspect, another embodiment of this application further provides an antenna apparatus, including a radiating element and the feed network assembly according to the first aspect. The radiating element is electrically connected to the transmission structure of the feed network.

According to the antenna apparatus in this embodiment of this application, the feed network according to the first aspect is disposed, so that processing and assembly of the antenna apparatus can be convenient, thereby reducing costs of the antenna apparatus.

Other features and advantages of this application will be described in this specification that follows, and in part will be obvious from this specification, or be learned by practice of this application. Objectives and other advantages of this application may be implemented and obtained by using structures specially specified in the written specification, claims, and accompanying drawings.

### BRIEF DESCRIPTION OF DRAWINGS

FIG. 1A is a diagram of a feed network assembly in a conventional technology according to an embodiment of this application;

FIG. 1B is a diagram of an antenna system according to an embodiment of this application;

FIG. 2 is a diagram of an antenna apparatus according to an embodiment of this application;

FIG. 3 is a diagram of a structure of a feed network assembly according to an embodiment of this application;

FIG. 4 is a three-dimensional view of a feed network assembly according to an embodiment of this application;

FIG. 5 is a diagram in which a first slot and a second slot of a feed network assembly are oppositely formed according to an embodiment of this application;

FIG. 6 is a diagram in which a first slot and a second slot of a feed network assembly are staggered according to an embodiment of this application;

FIG. 7 is a diagram of an “L”-shaped intermediate baffle plate of a feed network assembly according to an embodiment of this application;

FIG. 8 is a diagram in which a third slot and a fourth slot of a feed network assembly are staggered according to an embodiment of this application;

FIG. 9 is a diagram in which a third slot and a fourth slot of a feed network assembly are oppositely formed according to an embodiment of this application;

FIG. 10 is a diagram of an “I”-shaped intermediate baffle plate of a feed network assembly according to an embodiment of this application;

FIG. 11 is a diagram in which an intermediate baffle plate and a lower side wall of an accommodating cavity of a feed network assembly are integrally formed according to an embodiment of this application;

FIG. 12 is a diagram in which an intermediate baffle plate and an upper side wall of an accommodating cavity of a feed network assembly are integrally formed according to an embodiment of this application;

FIG. 13 is a diagram of a distance between slots of a feed network assembly according to an embodiment of this application;

FIG. 14 is a diagram of a slot depth of a feed network assembly according to an embodiment of this application;

FIG. 15 is a diagram in which a slot of a feed network assembly is formed on an upper side wall of an accommodating cavity according to an embodiment of this application;

FIG. 16 is a diagram in which a depth of a slot of a feed network assembly is greater than a width of a coupling area according to an embodiment of this application;

FIG. 17 is a diagram in which a transmission structure of a feed network assembly is disposed at the bottom of an accommodating cavity according to an embodiment of this application;

FIG. 18 is a diagram of a first side wall when a bent edge of a cover plate of a feed network assembly is downwardly coupled to a side wall according to an embodiment of this application;

FIG. 19 is a diagram of forming a slot on a cover plate of a feed network assembly according to an embodiment of this application;

FIG. 20 is a diagram of forming a slot on a side wall of a feed network assembly according to an embodiment of this application;

FIG. 21 is a diagram of an “L”-shaped intermediate baffle plate when a first side wall of a feed network assembly is shown in FIG. 18 according to an embodiment of this application;

FIG. 22 is a diagram of an “I”-shaped intermediate baffle plate when a first side wall of a feed network assembly is shown in FIG. 18 according to an embodiment of this application;

FIG. 23 is a diagram in which an intermediate baffle plate and a ground plane are integrally formed when a first side wall of a feed network assembly is shown in FIG. 18 according to an embodiment of this application;

FIG. 24 is a diagram in which a bent edge of a cover plate of a feed network assembly is downwardly coupled to a ground plane according to an embodiment of this application;

FIG. 25 is a diagram of an “L”-shaped intermediate baffle plate when a first side wall of a feed network assembly is shown in FIG. 24 according to an embodiment of this application;

FIG. 26 is a diagram of an “I”-shaped intermediate baffle plate when a first side wall of a feed network assembly is shown in FIG. 24 according to an embodiment of this application;

FIG. 27 is a diagram in which an intermediate baffle plate and a ground plane are integrally formed when a first side wall of a feed network assembly is shown in FIG. 24 according to an embodiment of this application;

FIG. 28 is a diagram in which a bent edge of a cover plate of a feed network assembly is downwardly coupled to an upward bent edge of a ground plane according to an embodiment of this application;

FIG. 29 is a diagram of forming a slot on a ground plane of a feed network assembly according to an embodiment of this application;

FIG. 30 is a diagram of an “L”-shaped intermediate baffle plate when a first side wall of a feed network assembly is shown in FIG. 28 according to an embodiment of this application;

FIG. 31 is a diagram of an “I”-shaped intermediate baffle plate when a first side wall of a feed network assembly is shown in FIG. 28 according to an embodiment of this application; and

FIG. 32 is a diagram in which an intermediate baffle plate and a ground plane are integrally formed when a first side wall of a feed network assembly is shown in FIG. 28 according to an embodiment of this application.

### DESCRIPTION OF EMBODIMENTS

Embodiments described below with reference to the accompanying drawings are examples, and are intended to explain the present invention only, but should not be construed as a limitation on the present invention.

To better understand technical solutions of this application, the following describes embodiments of this application in detail with reference to the accompanying drawings.

It should be noted that described embodiments are merely some rather than all of embodiments of this application. All other embodiments obtained by a person of ordinary skill in the art based on embodiments of this application without creative efforts shall fall within the protection scope of this application.

Terms used in embodiments of this application are merely for the purpose of illustrating specific embodiments, and are not intended to limit this application. Terms “a”, “the foregoing”, and “the” of singular forms used in embodiments and the appended claims of this application are also intended to include plural forms, unless otherwise specified in the context clearly.

It should be understood that a term “and/or” used in this specification describes only an association relationship between associated objects and represents that three relationships may exist. For example, A and/or B may represent the following three cases: Only A exists, both A and B exist, and only B exists. In addition, a character “/” in this specification generally indicates an “or” relationship between the associated objects.

An embodiment of this application provides an antenna apparatus, which may be used in a communication device. The communication device may be a communication base station, for example, a public mobile communication base station. The communication device, for example, the communication base station, is an interface device for a mobile device to access the internet, and is also a form of radio station. In a specific radio coverage area, information may be transmitted between the communication base station (mobile communication switching center) and the mobile device.

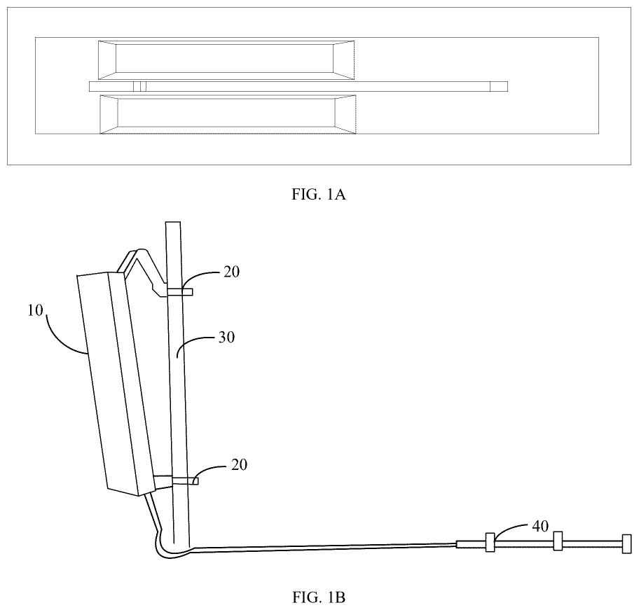

A main component for information transmission between the communication base station and the mobile device is an antenna system. Generally, as shown in FIG. 1B, an antenna system 1 may include an antenna apparatus 10, a fastening bracket 20, a pole 30, a grounding apparatus 40, and the like. The antenna apparatus 10 is fastened to the pole 30 through the fastening bracket 20. During actual application, a position and a mounting angle of the antenna apparatus 10 on the pole 30 may be adjusted by adjusting a position and an angle of the fastening bracket 20.

In addition, one end of the antenna apparatus 10 may be further connected to the grounding apparatus 40 through a connecting piece, to ensure that the antenna apparatus 10 is grounded. Connector sealing pieces are disposed at one end that is of the connecting piece and that is connected to the antenna apparatus 10 and one end that is of the connecting piece and that is connected to the grounding apparatus 40, to ensure sealing of the connections of the two ends of the connector to the antenna apparatus 10 and the grounding apparatus 40. It may be understood that the connector sealing piece may be an insulation sealing tape, for example, a polyvinyl chloride (Polyvinyl chloride, PVC for short) insulation tape.

During specific application, the antenna apparatus 10 is generally located in a radome. The radome is a housing structure outside the antenna apparatus 10. The radome is a structural part that protects the antenna apparatus 10 from being affected by an external environment. In terms of electrical performance, the radome provides high electromagnetic wave penetration. In terms of mechanical performance, the radome can withstand external harsh environment condition. The antenna apparatus 10 is protected by using the radome, to prevent the antenna apparatus 10 from being damaged due to dust accumulation or water ingress.

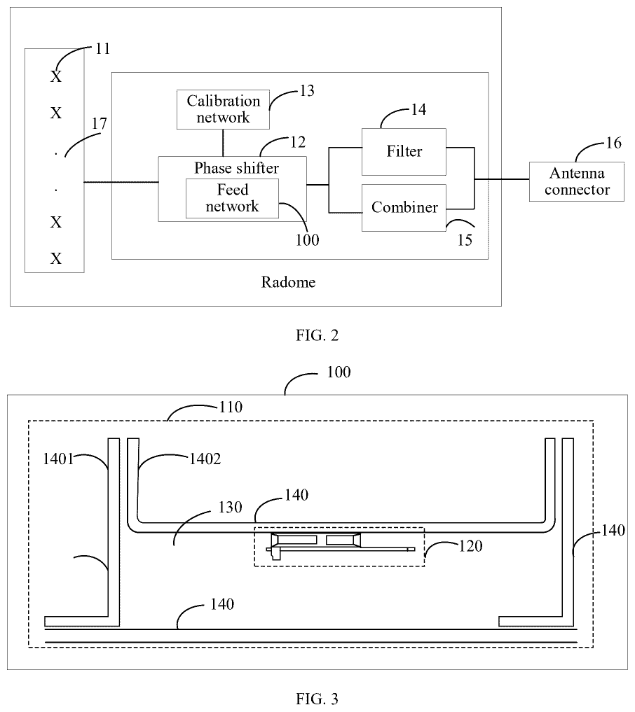

As shown in FIG. 2, the antenna apparatus 10 in embodiments of this application may include at least one independent array formed by a radiating element 11 and a reflection plate 17. Frequencies of radiating elements 11 may be the same or different. The radiating element 11 is usually placed above the reflection plate 17. The array receives or transmits radio frequency signals through respective feed network assemblies 100. The antenna apparatus 10 may further include a phase shifter 12 connected to the radiating element 11. The phase shifter 12 is configured to implement real-time change of network coverage, and adjust a signal phase to implement electrical downtilt of an array antenna.

The feed network assembly 100 is disposed in the phase shifter 12, and the feed network assembly 100 is electrically connected to the radiating element 11 and an antenna connector 16. The feed network assembly 100 may feed a radio frequency signal to the radiating element 11 based on a specific amplitude and phase, or send a received radio signal to a signal processing unit of a radio frequency device such as a communication base station based on a specific amplitude and phase.

For example, one end that is of the antenna connector 16 and that is away from the feed network may be electrically connected to a radio frequency circuit (not shown in the figure), so that a radio frequency signal is transmitted between the radiating element 11 and the radio frequency circuit. For example, the other end of the antenna connector 16 is electrically connected to a radio frequency signal port in the radio frequency circuit.

When the antenna apparatus is a transmit antenna, the radio frequency circuit may provide a signal source for the antenna apparatus. For example, the other end of the antenna connector 16 may be electrically connected to the radio frequency signal port in the radio frequency circuit, that is, the feed network assembly 100 is electrically connected to the radio frequency signal port in the radio frequency circuit. In this way, the radio frequency signal port may send a radio frequency signal, and feed the radio frequency signal to the radiating element 11 in a form of current. Then, the radiating element 11 sends the radio frequency signal in a form of electromagnetic wave, and the radio frequency signal is received by a receive antenna in a mobile device.

When the antenna apparatus is a receive antenna, the radio frequency circuit may receive a radio frequency signal fed back by the antenna apparatus. For example, the radiating element 11 of the antenna apparatus converts a received electromagnetic wave signal into a current signal, and then transmits the current signal to the radio frequency circuit through the feed network assembly 100, and then the signal processing unit performs subsequent processing.

The radio frequency circuit includes a remote radio unit (Remote Radio Unit, RRU for short), which forms a part of a remote radio unit radio frequency circuit, and the radio frequency signal port is usually disposed in the remote radio unit. For specific circuit configurations and a working principle of the radio frequency circuit, directly refer to related content in a conventional technology. Details are not described herein.

During actual application, with wide application and development of 5G technologies, a base station antenna develops toward a plurality of bands and a plurality of arrays, and integration of the antenna apparatus is increasingly high. For example, the antenna apparatus may include a plurality of radiating elements 11 and a plurality of feed network assemblies 100, and the feed network assemblies 100 are disposed in one-to-one correspondence with the radiating elements 11, so that the antenna apparatus forms an array antenna. Each radiating element 11 is electrically connected to a corresponding feed network assembly 100, so that each radiating element 11 is electrically connected to the radio frequency circuit through the respective feed network assembly 100, and each radiating element 11 receives or sends a radio frequency signal.

In addition, in some embodiments, the feed network assembly 100 may be further connected to a transmission component (not shown in the figure), to implement different radiation beam directions; or the feed network assembly 100 may be further connected to a calibration network, to obtain a system-required calibration signal. In addition, a module configured to expand performance such as a combiner 15 or a filter 14 may be further disposed between the feed network assembly 100 and the antenna connector 16, to improve performance of the antenna apparatus 10. The phase shifter 12, the filter 14, the calibration network 13, and the combiner 15 are not further limited in embodiments of this application.

With reference to the accompanying drawings, the following describes in detail the feed network assembly 100 provided in embodiments of this application.

For ease of description, in embodiments of this application, a length direction of the feed network assembly 100 is set to a first direction, a thickness direction is set to a second direction, and a direction perpendicular to the first direction and the second direction is a third direction.

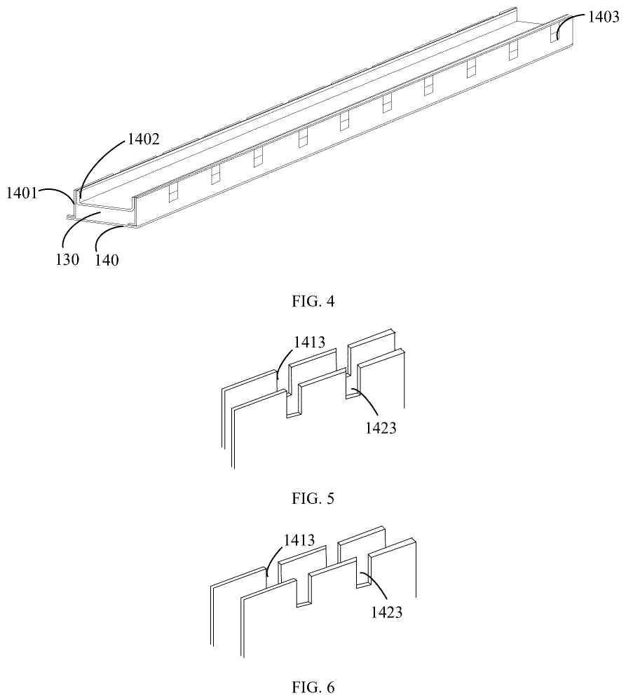

FIG. 3 is a diagram of a structure of the feed network assembly 100. FIG. 4 is a three-dimensional view of the feed network assembly 100. The feed network assembly 100 includes a cavity 110 and a transmission structure 120. The cavity includes an accommodating cavity 130, and the accommodating cavity 130 is configured to accommodate the transmission structure 120. The cavity 110 further includes a first side wall 140, the first side wall 140 includes a first sub-side wall 1401 and a second sub-side wall 1402 that are oppositely disposed and capacitively coupled, and at least one of the first sub-side wall 1401 and the second sub-side wall 1402 that are oppositely disposed and capacitively coupled includes at least one slot 1403 (not shown in FIG. 3).

In this application, slots are formed in the first sub-side wall 1401 and the second sub-side wall 1402 that are oppositely disposed and capacitively coupled, so that an area of relative disposition is reduced, thereby reducing resonance and improving transmission efficiency.

In this embodiment of this application, as shown in FIG. 3, the first side wall 140 is a side wall of the accommodating cavity 130, the first sub-side wall 1401 is integrally connected to a side wall of the accommodating cavity 130, and the second sub-side wall 1402 is integrally connected to the side wall of the accommodating cavity 130. In other words, the first sub-side wall extends from the side wall of the accommodating cavity.

In some possible embodiments, as shown in FIG. 5, in the first sub-side wall 1401 and the second sub-side wall 1402 that are oppositely disposed and capacitively coupled, the first sub-side wall 1401 includes at least two first slots 1413, and the second sub-side wall includes at least two second slots 1423; and the first slot 1413 and the second slot 1423 are staggered.

In this application, slots are staggered, so that a structure of the feed network can be more stable, thereby prolonging a service life of the feed network and reducing costs.

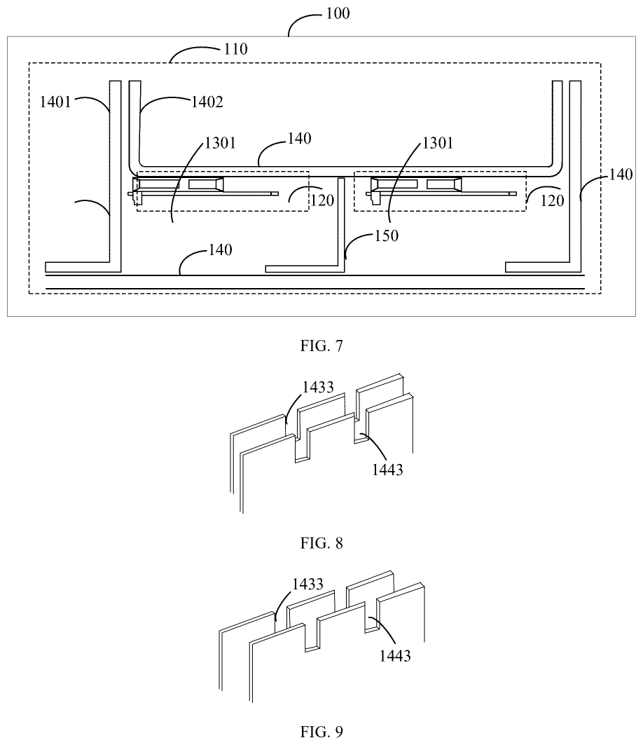

In some other possible embodiments, as shown in FIG. 6, in the first sub-side wall 1401 and the second sub-side wall 1402 that are oppositely disposed and capacitively coupled, the first sub-side wall 1401 includes at least two first slots 1413, and the second sub-side wall 1402 includes at least two second slots 1423; and the first slot 1413 and the second slot 1423 are oppositely formed.

In this application, when slots are formed on both the first sub-side wall and the second sub-side wall, the first slot on the first sub-side wall and the second slot on the second sub-side wall may be oppositely formed or may be staggered. A manner of forming a slot in this application is more flexible, making this application more universal.

In some possible embodiments, the feed network assembly 100 further includes at least one intermediate baffle plate 150, the intermediate baffle plate 150 is disposed in the accommodating cavity 130, the intermediate baffle plate 150 divides the accommodating cavity 130 into at least two accommodating sub-cavities 1301, and the transmission structure 120 is disposed in each accommodating sub-cavity 1301; and at least one end of the intermediate baffle plate 150 is coupled to a side wall of the accommodating cavity 130.

In this application, the intermediate baffle plate 150 is disposed to divide the accommodating cavity 130 into a plurality of accommodating sub-cavities 1301. In this way, transmission structures 120 in different accommodating sub-cavities 1301 may be connected to radiating elements with different polarizations of the antenna apparatus, so that requirements of the radiating elements with different polarizations can be met through one feed network assembly 100, thereby simplifying a structure of the feed network assembly 100 and reducing costs.

It should be noted that a quantity of intermediate baffle plates 150 is not limited in this application. To be specific, one intermediate baffle plate 150 may be disposed to divide the accommodating cavity 130 into two accommodating sub-cavities 1301, two intermediate baffle plates 150 may be disposed to divide the accommodating cavity 130 into three accommodating sub-cavities 1301, three intermediate baffle plates 150 may be disposed to divide the accommodating cavity 130 into four accommodating sub-cavities 1301, and so on.

In some possible embodiments, to further reduce resonance, a target end 1501 and the side wall of the accommodating cavity are oppositely disposed, and at least one of the target end 1501 and the side wall of the accommodating cavity that are oppositely disposed includes at least one slot; and the target end 1501 is an end that is of the intermediate baffle plate 150 and that is coupled to the side wall of the accommodating cavity.

For example, as shown in FIG. 7, the intermediate baffle plate 150 is configured in an “L” type, and a lower end of the intermediate baffle plate is coupled to the side wall of the accommodating cavity. In this case, the lower end of the intermediate baffle plate 150 is the target end.

In this application, slots are formed in the target end and the side wall of the accommodating cavity that are oppositely disposed and capacitively coupled, so that an area of relative disposition is reduced, thereby reducing resonance and improving transmission efficiency.

In some possible embodiments, as shown in FIG. 8 (FIG. 8 shows only the intermediate baffle plate and the side wall of the accommodating cavity), in the target end 1501 and the side wall of the accommodating cavity that are oppositely disposed, the target end 1501 includes at least two third slots 1433, and the side wall of the accommodating cavity includes at least two fourth slots 1443; and the third slot 1433 and the fourth slot 1443 are staggered.

In this application, when there are a large quantity of slots, the slots may be staggered, to ensure stability of the feed network assembly, thereby prolonging a service life of the feed network assembly.

In some other possible embodiments, as shown in FIG. 9, in the target end 1501 and the side wall of the accommodating cavity that are oppositely disposed, the target end 1501 includes at least two third slots 1433, and the side wall of the accommodating cavity includes at least two fourth slots 1443; and the third slot 1433 and the fourth slot 1443 are oppositely formed.

In this application, when slots are formed on both the target end 1501 and the side wall of the accommodating cavity, the third slot 1433 on the target end 1501 and the fourth slot 1443 on the side wall of the accommodating cavity may be oppositely formed or may be staggered. A manner of forming a slot in this application is more flexible, making this application more universal.

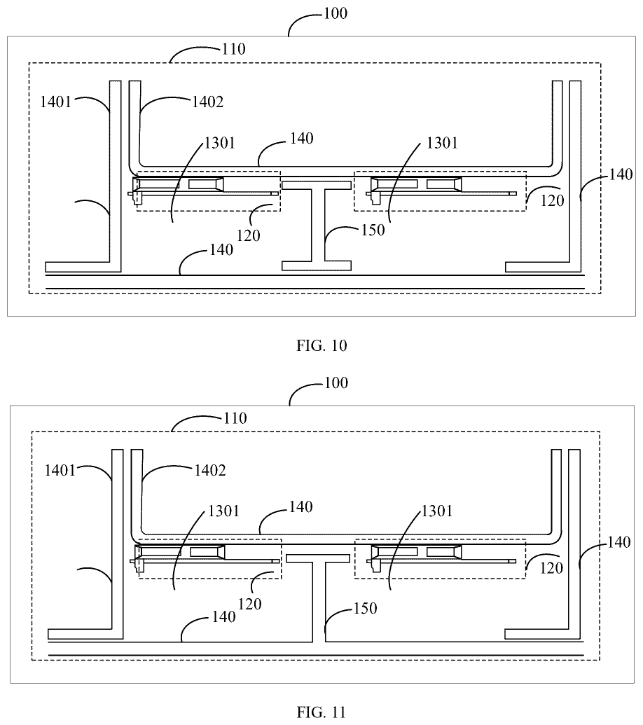

In some possible embodiments, in addition to the “L” shape shown in FIG. 7, the intermediate baffle plate 150 may alternatively be configured as an “I”-shaped metal structure shown in FIG. 10. The intermediate baffle plate 150 of the I-shaped structure and the side wall of the accommodating cavity may be coupled, or may be directly connected by using a screw or the like. When the intermediate baffle plate 150 of the I-shaped structure is coupled to the side wall of the accommodating cavity, a method for determining the target end of the intermediate baffle plate and a slotting method are the same as those in FIG. 7, and details are not described herein again.

In some other possible embodiments, as shown in FIG. 11, the intermediate baffle plate 150 may alternatively be integrally formed with a lower side wall of the accommodating cavity. In this case, an upper end of the intermediate baffle plate 150 is the target end 1501. A slotting method of the target end 1501 and the side wall of the accommodating cavity is the same as that in FIG. 7, and details are not described herein again.

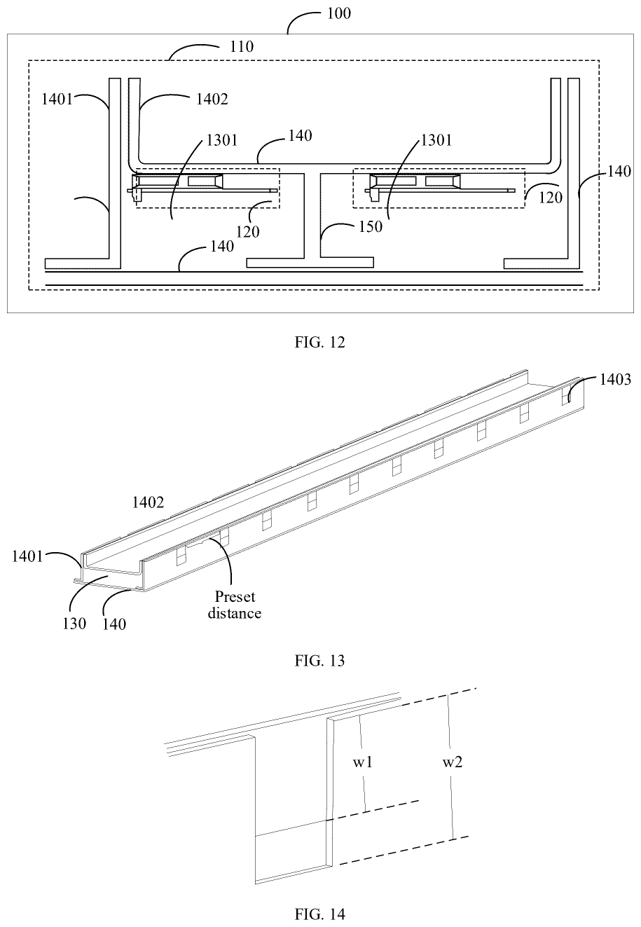

In some other possible embodiments, as shown in FIG. 12, the intermediate baffle plate 150 may alternatively be integrally formed with an upper side wall of the accommodating cavity. In this case, an upper end of the intermediate baffle plate 150 is the target end 1501. A slotting method of the target end 1501 and the side wall of the accommodating cavity is the same as that in FIG. 7, and details are not described herein again.

In some possible embodiments, as shown in FIG. 13 (an example in which a slot is formed on the second sub-side wall 1402 is used), at least one of the first sub-side wall 1401 and the second sub-side wall 1402 that are oppositely disposed and capacitively coupled includes at least two slots arranged in a first direction, and a distance between adjacent slots in the first direction in the at least two slots arranged in the first direction is a preset distance. The preset distance may be set to an integer multiple of a quarter of an operating wavelength, and the operating wavelength is an operating wavelength of the antenna apparatus corresponding to the feed network assembly 100.

In some possible embodiments, as shown in FIG. 14, a depth (w2 in FIG. 14) of the slot in a second direction is greater than a width (w1 in FIG. 14) of a coupling area, and the coupling area is a coupling connection area in which the slot is located.

In this application, the depth of the slot is set to be greater than the width of the coupling area, so that an area in which the first sub-side wall and the second sub-side wall are oppositely disposed is reduced, thereby reducing resonance.

In some other possible embodiments, as shown in FIG. 14, a length (l1 in FIG. 14) of the slot in the first direction is less than a half of the operating wavelength, and the operating wavelength is the operating wavelength of the antenna apparatus corresponding to the feed network assembly.

In this application, a distance between adjacent slots is set to be less than the preset distance, so that resonance generated because metal on two sides of the slots forms a coupling connection due to a gap in the middle is avoided, thereby further ensuring transmission efficiency.

It should be noted that a manner of forming slots in the target end and the side wall of the accommodating cavity is the same as a manner of forming slots in the first sub-side wall and the second sub-side wall, and details are not described herein again.

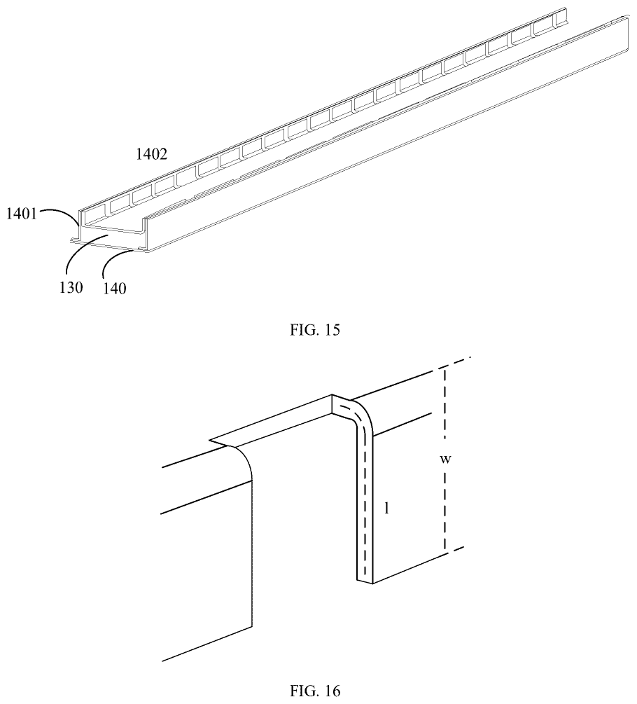

In some possible embodiments, in addition to being formed on side walls on two sides of the accommodating cavity shown in FIG. 13, the slot may also be formed on an upper side wall of the accommodating cavity, as shown in FIG. 15. In this case, to ensure that the depth of the slot is greater than the width of the coupling area, as shown in FIG. 16, l needs to be greater than w.

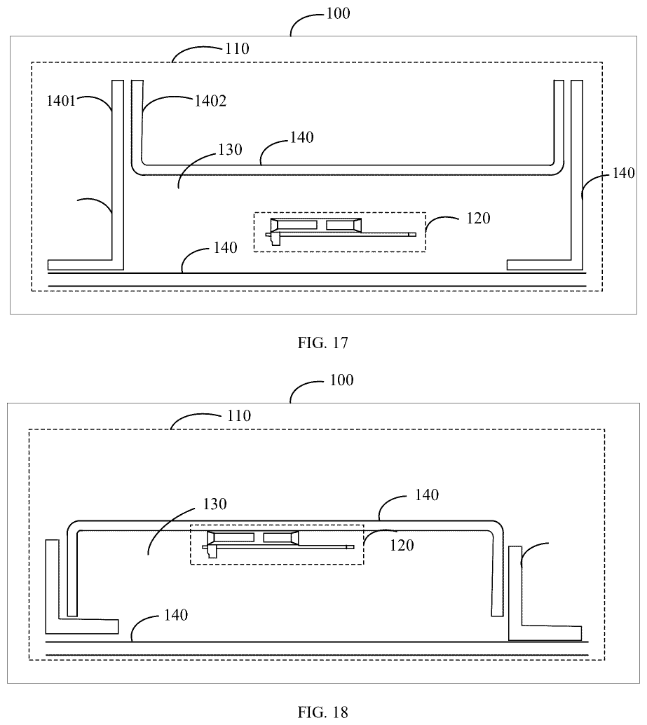

In some possible embodiments, the transmission structure 120 includes a transmission strip and a phase-shift medium. A manner of disposing the transmission structure in the accommodating cavity may be shown in FIG. 3, that is, the transmission structure is disposed on the top of the accommodating cavity, or may be shown in FIG. 17, that is, the transmission structure is disposed at the bottom of the accommodating cavity. It should be noted that a position of the transmission structure in the accommodating cavity is not limited in this application.

It should be noted that a position at which the transmission structure 120 is disposed is not further limited in embodiments. In addition, a size of the accommodating cavity 130 is not further limited to the structure in embodiments, provided that the transmission structure 120 can be easily assembled.

For ease of further understanding of the feed network assembly provided in embodiments of this application, the following describes in detail the first side wall of the feed network assembly.

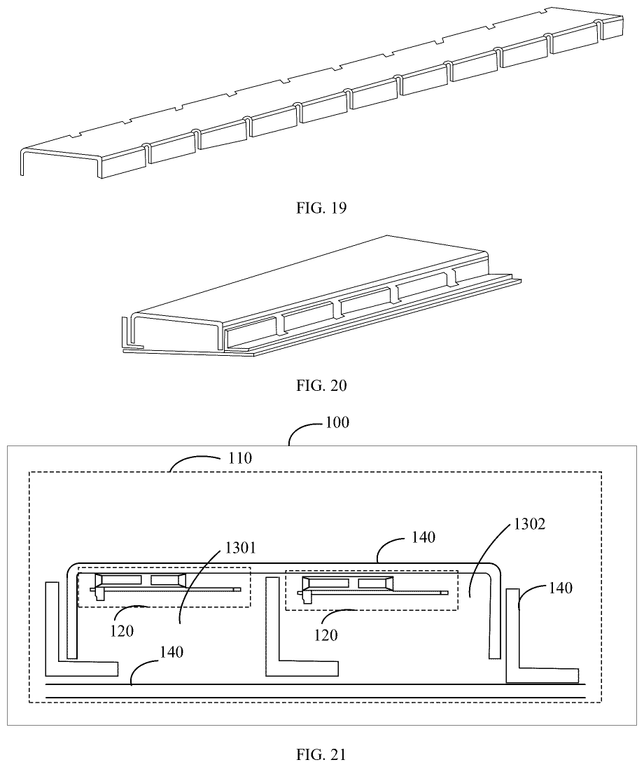

In some possible embodiments, the first side wall 140 includes a cover plate 1403, a ground plane 1404, and a side wall 1405. As shown in FIG. 18, a bent edge of the cover plate 1403 may be downwardly coupled to the side wall 1405. If a slot is formed on the cover plate 1403, the slot is shown in FIG. 19. If a slot is formed on the side wall 1405, the slot is shown in FIG. 20.

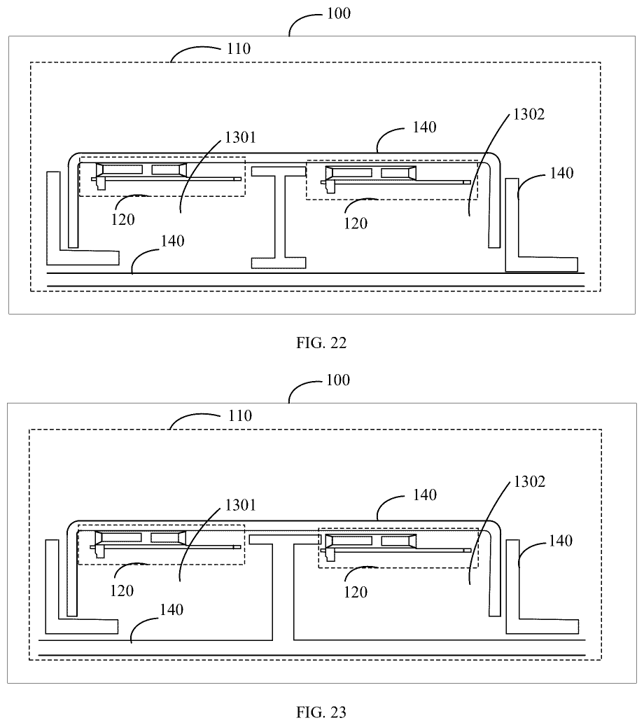

When the first side wall 140 is shown in FIG. 18, the intermediate baffle plate 150 may be configured as an “L” shape shown in FIG. 21 or an “I” shape shown in FIG. 22, or the intermediate baffle plate 150 and the ground plane 1404 shown in FIG. 23 are integrally formed. It should be noted that a specific style of the intermediate baffle plate is not limited in this application. A manner of connecting the intermediate baffle plate 150 and the first side wall 140 and a slotting method are the same as those described above, and details are not described herein again.

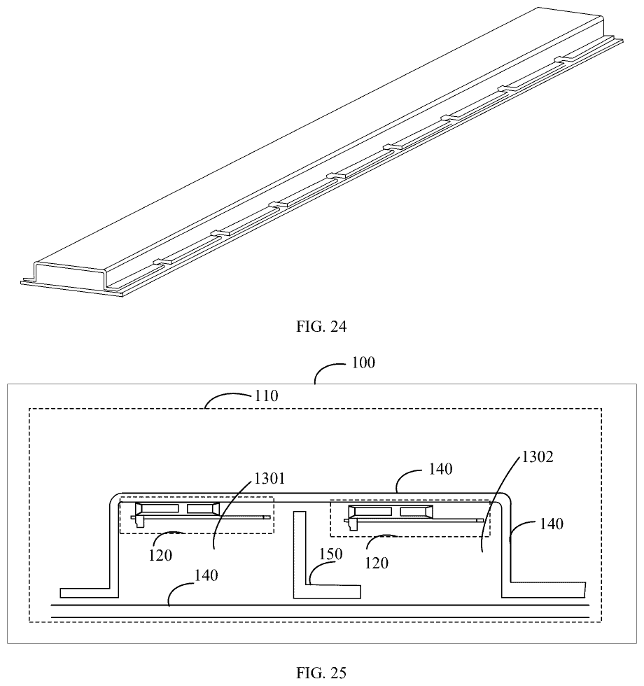

In some other possible embodiments, the first side wall 140 includes a cover plate 1403 and a ground plane 1404. As shown in FIG. 24, a bent edge of the cover plate 1403 may be downwardly coupled to the ground plane 1404. If a slot is formed on the cover plate 1403, the slot is shown in FIG. 24.

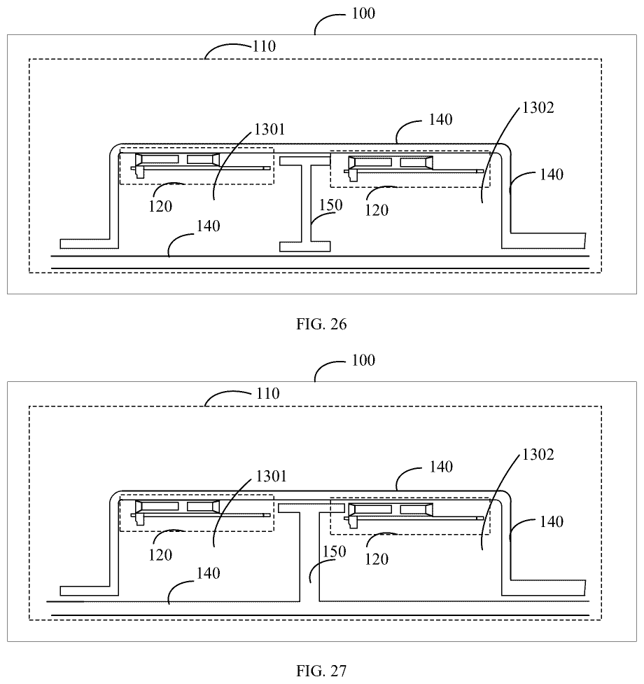

When the first side wall 140 is shown in FIG. 24, the intermediate baffle plate 150 may be configured as an “L” shape shown in FIG. 25 or an “I” shape shown in FIG. 26, or the intermediate baffle plate 150 and the ground plane 1404 shown in FIG. 27 are integrally formed. It should be noted that a specific style of the intermediate baffle plate is not limited in this application. A manner of connecting the intermediate baffle plate 150 and the first side wall 140 and a slotting method are the same as those described above, and details are not described herein again.

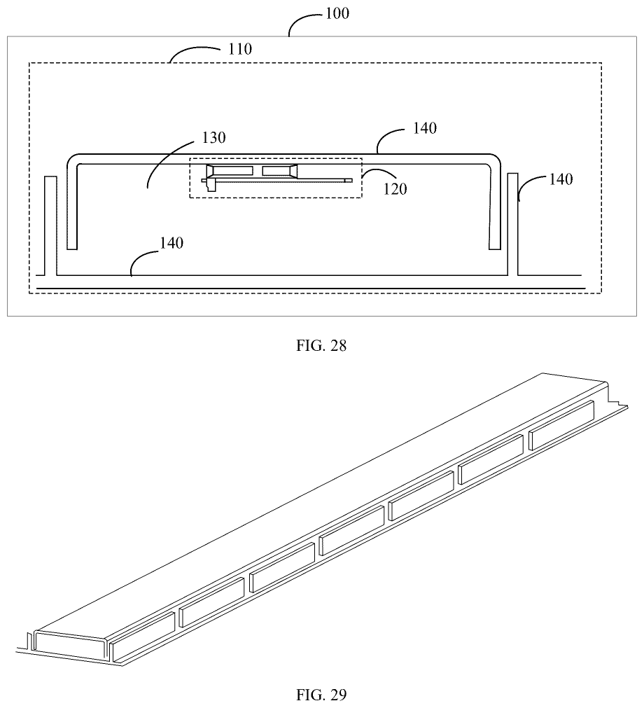

In some other possible embodiments, the first side wall 140 includes a cover plate 1403 and a ground plane 1404. As shown in FIG. 28, a bent edge of the cover plate 1403 may be downwardly coupled to an upward bent edge of the ground plane 1404. If a slot is formed on the cover plate 1403, the slot is shown in FIG. 19. If a slot is formed on the ground plane 1404, the slot is shown in FIG. 29.

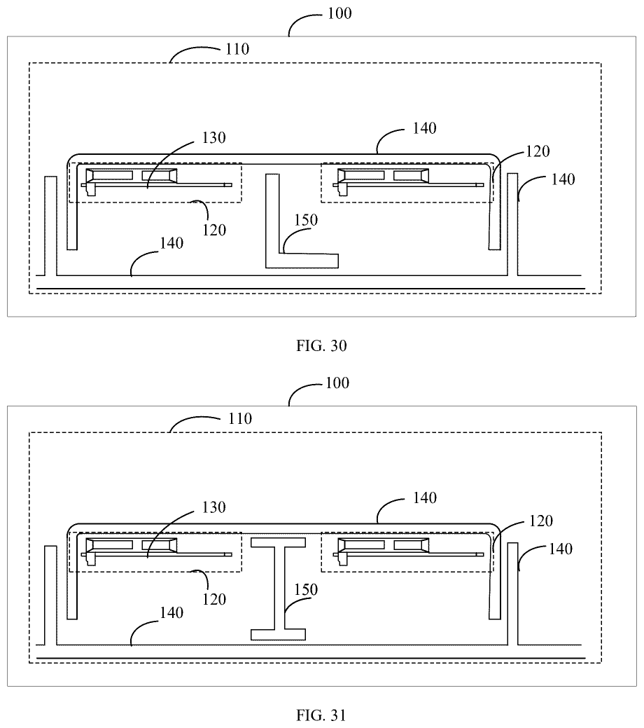

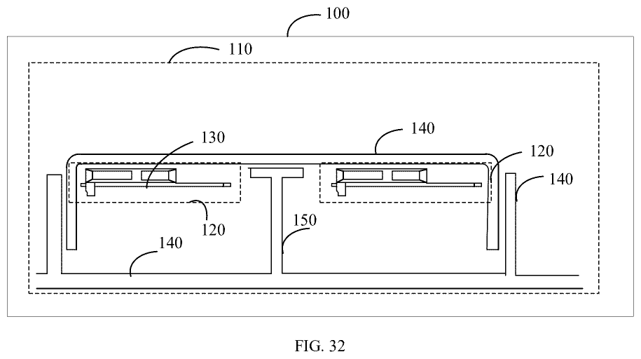

When the first side wall 140 is shown in FIG. 28, the intermediate baffle plate 150 may be configured as an “L” shape shown in FIG. 30 or an “I” shape shown in FIG. 31, or the intermediate baffle plate 150 and the ground plane 1404 shown in FIG. 32 are integrally formed. It should be noted that a specific style of the intermediate baffle plate is not limited in this application. A manner of connecting the intermediate baffle plate 150 and the first side wall 140 and a slotting method are the same as those described above, and details are not described herein again.

It should be noted that according to the phase shifter provided in embodiments of this application, the foregoing feed network assembly 100 is disposed, so that a structure can be simplified, thereby reducing costs. According to the antenna apparatus in embodiments of this application, the feed network assembly 100 in the first aspect is disposed, so that a structure of the antenna apparatus can be simplified, thereby reducing costs of the antenna apparatus.

It should be understood that, in this application, an “electrical connection” may be understood as physical contact and electrical conduction between components, or a coupling connection, or may be understood as a form in which different components in a line structure are connected through a physical line that can transmit an electrical signal, such as a printed circuit board (printed circuit board, PCB) copper foil or conducting wire. The “coupling” may be understood as electrical conduction through air in an indirect coupling manner. The coupling in this application may be understood as capacitive coupling. For example, an equivalent capacitor is formed through coupling between gaps of two electric-conductors, to implement a signal transmission. A person skilled in the art may understand that a coupling phenomenon is a phenomenon that inputs and outputs of two or more circuit components or electrical networks closely cooperate with each other and affect each other and energy is transmitted from one side to the other side through interaction. A “communication connection” may refer to an electrical signal transmission, including a wireless communication connection and a wired communication connection. The wireless communication connection does not require a physical medium and does not belong to a connection relationship that defines a construction of a product. Both a “connection” and an “interconnection” may indicate a mechanical connection relationship or a physical connection relationship. To be specific, a connection between A and B or an interconnection between A and B may indicate that there is a fastening piece (such as a screw, a bolt, or a rivet) between A and B, or A and B are in contact with each other and A and B are difficult to be separated. For opposite/opposite disposition, that A and B are oppositely disposed may indicate that A and B are disposed opposite to each other or face to face (opposite to or face to face).

1. A feed network assembly, wherein the feed network assembly comprises a cavity and a transmission structure, wherein
the cavity comprises an accommodating cavity, and the accommodating cavity is configured to accommodate the transmission structure; and
the cavity further comprises a first side wall, the first side wall comprises a first sub-side wall and a second sub-side wall that are oppositely disposed and capacitively coupled, and at least one of the first sub-side wall and the second sub-side wall that are oppositely disposed and capacitively coupled comprises at least one slot.

2. The feed network assembly according to claim 1, wherein the first side wall is a side wall of the accommodating cavity, and the first sub-side wall is integrally connected to a side wall of the accommodating cavity.

3. The feed network assembly according to claim 1, wherein in the first sub-side wall and the second sub-side wall that are oppositely disposed and capacitively coupled, the first sub-side wall comprises at least two first slots, and the second sub-side wall comprises at least two second slots; and the first slot and the second slot are staggered.

4. The feed network assembly according to claim 1, wherein in the first sub-side wall and the second sub-side wall that are oppositely disposed and capacitively coupled, the first sub-side wall comprises at least two first slots, and the second sub-side wall comprises at least two second slots; and the first slot and the second slot are oppositely formed.

5. The feed network assembly according to claim 1, wherein the feed network assembly further comprises at least one intermediate baffle plate, the intermediate baffle plate is disposed in the accommodating cavity, the intermediate baffle plate divides the accommodating cavity into at least two accommodating sub-cavities, and the transmission structure is disposed in each accommodating sub-cavity; and
at least one end of the intermediate baffle plate is coupled to a side wall of the accommodating cavity.

6. The feed network assembly according to claim 5, wherein a target end and the side wall of the accommodating cavity are oppositely disposed, and at least one of the target end and the side wall of the accommodating cavity that are oppositely disposed comprises at least one slot; and the target end is an end that is of the intermediate baffle plate and that is coupled to the side wall of the accommodating cavity.

7. The feed network assembly according to claim 6, wherein in the target end and the side wall of the accommodating cavity that are oppositely disposed, the target end comprises at least two third slots, and the side wall of the accommodating cavity comprises at least two fourth slots; and the third slot and the fourth slot are staggered.

8. The feed network assembly according to claim 6, wherein in the target end and the side wall of the accommodating cavity that are oppositely disposed, the target end comprises at least two third slots, and the side wall of the accommodating cavity comprises at least two fourth slots; and the third slot and the fourth slot are oppositely formed.

9. The feed network assembly according to claim 1, wherein at least one of the first sub-side wall and the second sub-side wall that are oppositely disposed and capacitively coupled comprises at least two slots arranged in a first direction, and a distance between adjacent slots in the first direction in the at least two slots arranged in the first direction is a preset distance.

10. The feed network assembly according to claim 9, wherein the preset distance is an integer multiple of a quarter of an operating wavelength, and the operating wavelength is an operating wavelength of an antenna apparatus corresponding to the feed network assembly.

11. The feed network assembly according to claim 1, wherein a depth of the slot in a second direction is greater than a width of a coupling area, and the coupling area is a coupling connection area in which the slot is located.

12. The feed network assembly according to claim 1, wherein a length of the slot in the first direction is less than a half of the operating wavelength, and the operating wavelength is the operating wavelength of the antenna apparatus corresponding to the feed network assembly.

13. A phase shifter, comprising a feed network assembly, wherein the feed network assembly comprises a cavity and a transmission structure, wherein
the cavity comprises an accommodating cavity, and the accommodating cavity is configured to accommodate the transmission structure; and
the cavity further comprises a first side wall, the first side wall comprises a first sub-side wall and a second sub-side wall that are oppositely disposed and capacitively coupled, and at least one of the first sub-side wall and the second sub-side wall that are oppositely disposed and capacitively coupled comprises at least one slot.

14. The phase shifter according to claim 13, wherein the first side wall is a side wall of the accommodating cavity, and the first sub-side wall is integrally connected to a side wall of the accommodating cavity.

15. The phase shifter according to claim 13, wherein in the first sub-side wall and the second sub-side wall that are oppositely disposed and capacitively coupled, the first sub-side wall comprises at least two first slots, and the second sub-side wall comprises at least two second slots; and the first slot and the second slot are staggered.

16. The phase shifter according to claim 13, wherein in the first sub-side wall and the second sub-side wall that are oppositely disposed and capacitively coupled, the first sub-side wall comprises at least two first slots, and the second sub-side wall comprises at least two second slots; and the first slot and the second slot are oppositely formed.

17. The phase shifter according to claim 13, wherein the feed network assembly further comprises at least one intermediate baffle plate, the intermediate baffle plate is disposed in the accommodating cavity, the intermediate baffle plate divides the accommodating cavity into at least two accommodating sub-cavities, and the transmission structure is disposed in each accommodating sub-cavity; and
at least one end of the intermediate baffle plate is coupled to a side wall of the accommodating cavity.

18. The phase shifter according to claim 17, wherein a target end and the side wall of the accommodating cavity are oppositely disposed, and at least one of the target end and the side wall of the accommodating cavity that are oppositely disposed comprises at least one slot; and the target end is an end that is of the intermediate baffle plate and that is coupled to the side wall of the accommodating cavity.

19. The phase shifter according to claim 18, wherein in the target end and the side wall of the accommodating cavity that are oppositely disposed, the target end comprises at least two third slots, and the side wall of the accommodating cavity comprises at least two fourth slots; and the third slot and the fourth slot are staggered.

20. An antenna apparatus, comprising a radiating element and a feed network assembly, wherein the radiating element is electrically connected to the transmission structure of the feed network, wherein the feed network assembly comprises a cavity and a transmission structure, wherein
the cavity comprises an accommodating cavity, and the accommodating cavity is configured to accommodate the transmission structure; and
the cavity further comprises a first side wall, the first side wall comprises a first sub-side wall and a second sub-side wall that are oppositely disposed and capacitively coupled, and at least one of the first sub-side wall and the second sub-side wall that are oppositely disposed and capacitively coupled comprises at least one slot.
